(19) United States
(12) Patent Application Publication
(10) Pub. No.: US 2026/0286961 A1
(43) Pub. Date: Sep. 24, 2026

(54) VACUUM PUMP

(71) Applicant: Edwards Limited, Burgess Hill, Sussex (GB)

(72) Inventor: Michael Henry North, Burgess Hill, Sussex (GB)

(21) Appl. No.: 19/473,641

(22) PCT Filed: May 9, 2024
(86) PCT No.: PCT/GB2024/051207

§ 371 Date: Oct. 8, 2025

(30) Foreign Application Priority Data
Jun. 1, 2023 (GB) 2308187.0

(51) Int. Cl. F04C 25/02; F04C 18/107

(52) U.S. Cl. CPC F04C 25/02; F04C 18/107

(57) ABSTRACT

A vacuum pump comprising: a stator comprising: a first end wall at a first end of the stator; a second end wall at a second end-of the stator, the second end of the stator being opposite to the first end of the stator; and one or more side walls disposed between the first end wall-and the second end wall; wherein the first end wall, the second end wall,and the one or more side walls define a pumping chamber; the first end wall comprises a first opening therethrough; and the vacuum pump further comprises a first end plate-removably disposed in the first opening.

### CROSS-REFERENCE TO RELATED APPLICATION

This application is a Section 371 National Stage Application of International Application No. PCT/GB2024/051207 filed May 9, 2024, and published as WO 2024/246482 A1 on Dec. 5, 2024, the content of which is hereby incorporated by reference in its entirety and which claims priority of British Application No. 2308187.0, filed Jun. 1, 2023.

### FIELD

The present invention relates to vacuum pumps.

### BACKGROUND

Vacuum pumps are used in various technical processes to pump gases out of process chambers, thereby to create low-pressure conditions for the respective processes.

In many vacuum pumps, thermal break plates may be installed between the pump stator and the headplates that house bearings for supporting the rotor shafts of the vacuum pump. The thermal break plates thermally insulate the relatively cooler headplates from the relatively hotter stator.

Conventionally, for each thermal break plate, two sealing gaskets (e.g., O-ring seals) are use: one to provide sealing between the thermal break plate and the stator, and one to provide sealing between the thermal break plate and the headplate.

The discussion above is merely provided for general background information and is not intended to be used as an aid in determining the scope of the claimed subject matter. The claimed subject matter is not limited to implementations that solve any or all disadvantages noted in the background.

### SUMMARY

In an aspect, there is provided a vacuum pump. The vacuum pump comprises a stator having a first end wall at a first end of the stator, a second end wall at a second end of the stator, the second end of the stator being opposite to the first end of the stator, and one or more side walls disposed between the first end wall and the second end wall. The first end wall, the second end wall, and the one or more side walls define a pumping chamber therebetween. The first end wall comprises a first opening therethrough. This first opening may allow access to the pumping chamber, e.g. during machining of the stator. The vacuum pump further comprises a first end plate removably disposed in the first opening.

The first end plate is a thermal break plate. The first end plate may be made of the same material as the stator.

The first end plate may be wholly recessed in the first end wall. Thus, in some aspects, no part of the first end plate protrudes out of the opening, away from the pumping chamber, beyond a furthest part of the first end wall.

The first end wall may comprise a recessed flange extending inwards from internal walls of (or that define) the first opening. The first end plate may abut the recessed flange.

The vacuum pump may further comprise a sealing gasket, such as an O-ring, disposed against the first end wall and surrounding the first end plate. The sealing gasket may be disposed in a seal groove that surrounds the first opening. Preferably, no part of the first end plate protrudes out of the opening, away from the pumping chamber, beyond the sealing gasket. The sealing gasket may be made of a perfluoroelastomer, FFKM.

The vacuum pump may further comprise one or more (e.g., two) rotatable shafts, and a support member comprising bearings for mounting the rotatable shafts. Each rotatable shaft may comprise at least one rotor element. Each rotor element may be within the pumping chamber. Each rotatable shaft may extend beyond the first end of the stator, through a respective hole through the first end plate, and to the support member whereat that rotatable shaft is mounted on the bearings. The support member may be positioned facing the first end wall and the first end plate. The support member may be positioned spaced apart from the first end wall and the first end plate.

The first end plate may comprise a plurality (e.g. three or more, or exactly three) of locating protrusions extending therefrom. Each locating protrusion may be received in a respective hole formed in the support member.

The support member may comprise a plurality (e.g. three or more, or exactly three) of locating protrusions extending therefrom. Each locating protrusion may be received in a respective hole formed in the first end plate.

The locating protrusions may be made from a material selected from the group of materials consisting of stainless steel, carbon steel, and mild steel.

The sealing gasket may seal against the first end wall and the support member.

The vacuum pump may further comprise one or more ceramic spacers disposed between the first end wall and the support member.

The first end plate may comprise a purge gas channel. The purge gas channel may comprise an inlet for receiving a purge gas, and an outlet via which the purge gas may exit the purge gas channel.

The first end plate may comprise a first surface that is furthest from the pumping chamber, a second surface opposite to the first surface, the second surface being closest to the pumping chamber, and one or more side surfaces disposed between the first surface and the second surface. The outlet of the purge gas channel may be formed in the first surface. The inlet of the purge gas channel may be formed in the second surface or the one or more side surfaces.

The second end wall may comprise a second opening therethrough. This second opening may allow access to the pumping chamber, e.g. during machining of the stator such that the pumping chamber can be machined from both first and second ends. The vacuum pump may further comprise a second end plate (which may be substantially the same as the first end plate) removably disposed in the second opening.

The vacuum pump may comprise a dry screw vacuum pump.

The summary is provided to introduce a selection of concepts in a simplified form that are further described in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The present invention will now be described, by way of example only, with reference to the accompanying drawings, in which:

FIG. 1 is a schematic illustration (not to scale) showing a perspective view of an embodiment of a portion of a vacuum pump;

FIG. 2 is a schematic illustration (not to scale) showing a perspective view a first end of the portion of the vacuum pump;

FIG. 3 is a schematic illustration (not to scale) showing a cross section of the first end of the portion of a vacuum pump; and

FIG. 4 is a schematic illustration (not to scale) showing a further cross section of the first end of the vacuum pump.

### DETAILED DESCRIPTION

It will be appreciated that relative terms such as above and below, horizontal and vertical, top and bottom, front and back, and so on, are used herein merely for ease of reference to the Figures, and these terms are not limiting as such, and any two differing directions or positions and so on may be implemented rather than truly above and below, horizontal and vertical, top and bottom, and so on.

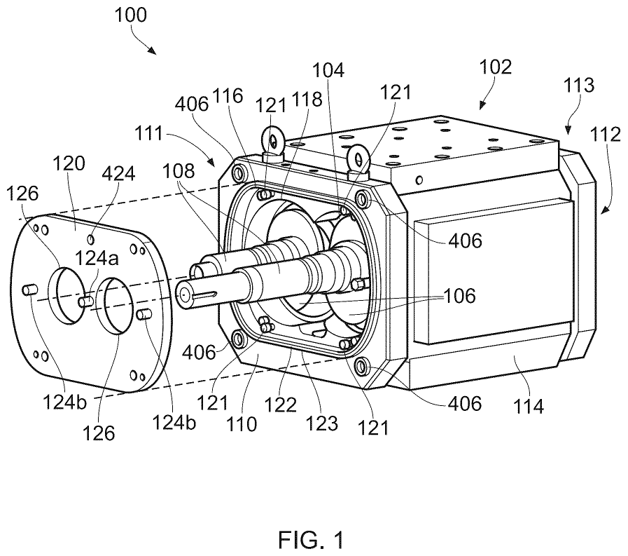

FIG. 1 is a schematic illustration (not to scale) showing a perspective view of an embodiment of a portion of a vacuum pump 100.

In this embodiment, the vacuum pump 100 is a dry rotary screw vacuum pump.

In this embodiment, the vacuum pump 100 comprises a housing or stator 102 defining a pumping chamber 104, and a pair of intermeshing clockwise and anticlockwise screw rotors 106 rotatably mounted within the pumping chamber 104. The screw rotors 106 are mounted to or integral with respective rotor shafts 108.

At one end of the stator 102 is formed a gas inlet (not shown). At another end of the stator 102, opposite to the end at which the gas inlet is located, is formed a gas outlet (not shown).

In operation, the rotor shafts 108, and thus the screw rotors 106, are rotated by a motor. Rotation of the screw rotors 106 by the motor causes process gas to be drawn into the pumping chamber 104 (in which the screw rotors 106 are rotating) via the gas inlet. Continued rotation of the screw rotors 106 moves the process gas through the pumping chamber 104, from a suction port to a discharge port. The process gas is subsequently forced out of the discharge port, and out of the vacuum pump 100 via the gas outlet.

The stator 102 comprises a first end wall 110 at a first end 111 of the stator, a second end wall 112 at a second end 113 of the stator 102, the second end 113 of the stator 102 being opposite to the first end 111 of the stator 102, and one or more side walls 114 disposed between the first end wall 110 and the second end wall 112. The first end wall 110, the second end wall 112, and the one or more side walls 114 define the pumping chamber 104.

The first end wall 110 comprises a first opening 116 therethrough. The first opening 116 is an opening to the pumping chamber 104 and advantageously tends to allow access to the pumping chamber 104, e.g. by a human or tool (such as a machining tool) during fabrication, servicing, or repair of the stator 102. The rotor shafts 108 extend out of the pumping chamber 104 via the first opening 116.

In this embodiment, the first end wall 110 comprises a recessed flange 118 extending from the internal walls of the first opening 116.

The vacuum pump 100 further comprises a first end plate 120. The first end plate 120 is disposed in the first opening 116 as indicated by dashed lines in FIG. 1. The first end plate 120 is removable from the first opening 116. In this embodiment, the first end plate 120 closes the first opening 116.

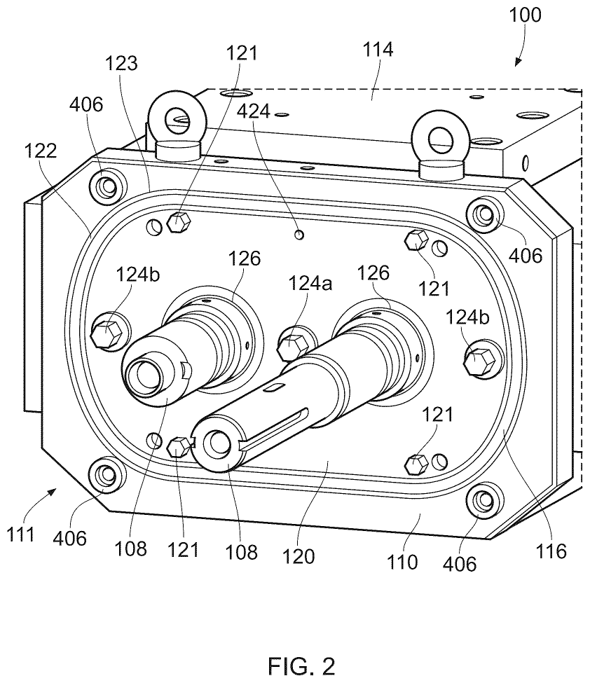

FIG. 2 is a schematic illustration (not to scale) showing a perspective view the first end 111 of the portion of a vacuum pump 100, with the first end plate 120 disposed in the first opening 116.

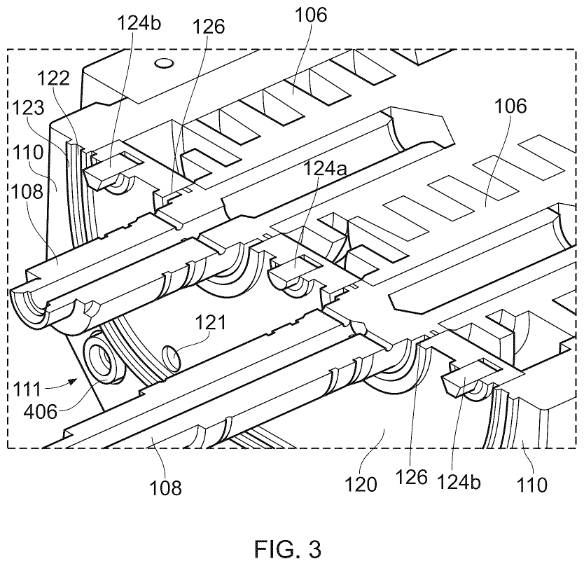

FIG. 3 is a schematic illustration (not to scale) showing a cross section of the first end 111 of the portion of a vacuum pump 100, with the first end plate 120 disposed in the first opening 116.

In this embodiment, the first end plate 120 is disposed in the first opening 116 such that the first end plate 120 abuts the recessed flange 118. The flange 118 may be considered to be a seat for the first end plate 120.

In this embodiment, the first end plate 120 is fixedly attached to the stator 102 by a plurality (e.g., four) of fasteners 121 which pass through the first end plate 120 and into the flange 118. Thus, the first end plate 120 is attached to the flange 118.

In this embodiment, the first end plate 120 may be at least partially, and more preferably wholly, recessed in the first end wall 110. Preferably, no part of the first end plate 120 extends or protrudes out of the first opening 116, in an axial direction away from the pumping chamber 104, beyond a distal or furthest part of the first end wall 110.

In this embodiment, the vacuum pump 100 further comprises a sealing gasket 122. The sealing gasket 122 may be an O-ring sealing gasket. The sealing gasket 122 is positioned against the first end wall 110. The sealing gasket 122 surrounds the first opening 116 and, thus, the first end plate 120. Preferably, the sealing gasket 122 is disposed in a seal groove 123 formed in the first end wall 110. The seal groove 123 surrounds the first opening 116.

The first end plate 120 being recessed in the first end wall 110 tends to provide that no part of the first end plate 120 extends or protrudes out of the first opening 116 beyond a furthest part of the sealing gasket 122 in an axial direction away from the pumping chamber 104.

Preferably, the sealing gasket 122 is made of a perfluoroelastomer, and more preferably FFKM. FFKM tends to have a relatively high maximum continuous service temperature compared to other sealing gasket materials. The FFKM sealing gasket is especially useful in applications that involve contact with hydrocarbons or highly corrosive fluids, and/or in applications in which a wide range of temperatures is encountered.

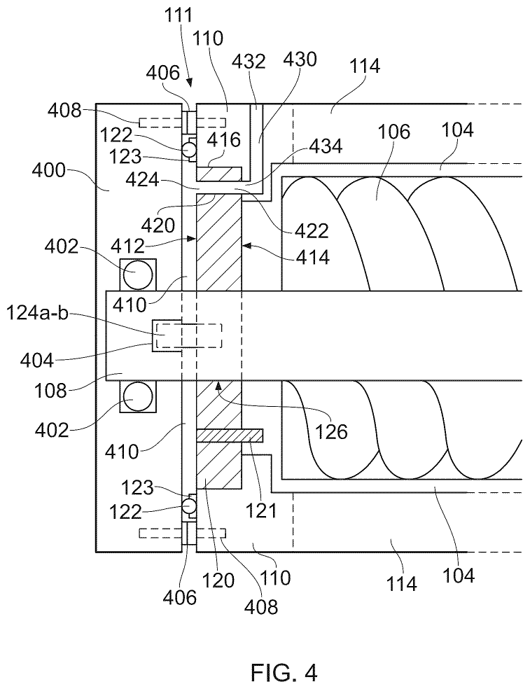

In this embodiment, the first end plate 120 comprises three dowels or locating protrusions 124a-b extending therefrom. The dowels or locating protrusions 124a-b may be fitted into dowel holes machined into the first end plate 120. The locating protrusions 124a-b are arranged on the horizontal centreline of the first end plate 120. As described in more detail later below with reference to FIG. 4, the locating protrusions 124a-b are for accurately positioning a support member or headplate carrying bearings for mounting the rotor shafts, and face the support member or headplate.

In this embodiment, there is one central locating protrusion 124a. The central locating protrusion 124a may have a substantially round cross-section. In addition, there are two edge locating protrusions 124b, located on each side of the central locating protrusion 124a. The two edge locating protrusions 124b have non-round cross sections, such as approximately polygonal (e.g., approximately hexagonal, such as hexagonal with one or more rounded sides and/or corners) cross sections. The two edge locating protrusions 124b may be known as “acorn dowels”.

The locating protrusions 124a-b extend from the first end plate 120 in an axial or longitudinal direction away from the pumping chamber 104. The locating protrusions 124a-b are spaced apart from one another over a first, outer surface (relative to the pumping chamber 104) of the first end plate 120. The locating protrusions 124a-b may be made from any appropriate material, and preferably a material that has lower thermal conductivity than the material(s) from which the first end plate 120 and/or the stator 102 are made. Examples of materials from which the locating protrusions 124a-b may be made include, but are not limited to, stainless steel, carbon steel, and mild steel. Preferably, the locating protrusions 124a-b are made of stainless steel.

In this embodiment, the first end plate 120 comprises two holes or apertures 126 through its structure. Each rotatable shaft 108 extends beyond the first end 111 of the stator 102, through a respective one of the apertures 126.

FIG. 4 is a schematic illustration (not to scale) showing a cross section of a first end of the vacuum pump 100. As shown in FIG. 4, the vacuum pump 100 further comprises a headplate or support member 400 comprising bearings 402 for mounting the rotatable shafts 108. Each rotatable shaft 108 extends beyond the first end 111 of the stator 102, through a respective aperture 126 through the first end plate 120, and to the support member 400 whereat that rotatable shaft 108 is mounted on the bearings 402.

The support member 400 is positioned at the first end 111 of the stator 102 facing the first end wall 110 and the first end plate 120.

In this embodiment, the locating protrusions 124a-b extending from the first end plate 120 are received in respective dowel holes 404 formed in the support member 400. The locating of the locating protrusions 124a-b in the respective dowel holes 404 advantageously tends to provide for accurate positioning of the support member 400 with respect to the first end plate 120, thus ensuring accurate positioning of the bearings 402 with respect to the rotatable shafts 108 that are to be mounted on the bearings 402.

In this embodiment, the support member 400 is spaced apart from the first end wall 110 and the first end plate 120 by the sealing gasket 122. The sealing gasket 122 forms a seal between the support member 400 and the first end 111 of the stator 102. More specifically, in this embodiment, the sealing gasket 122 is in sealing engagement with the first end wall 110 and the support member 400.

In this embodiment, the vacuum pump 100 further comprises a plurality of ceramic spacers 406. The ceramic spacers 406 are disposed between the first end wall 110 and the support member 400. The ceramic spacers 406 serve to space apart the support member 400 from the first end wall 110 and the first end plate 120, in a similar fashion to the sealing gasket 122. In this embodiment, the ceramic spacers 406 are disposed around fasteners 408 that fasten together the first end wall 110 and the support member 400.

In this embodiment, the sealing gasket 122 and the ceramic spacers 406 space apart the support member 400 from the first end wall 110 and the first end plate 120. Thus, there is a gap 410 between the support member 400 and the first end 111 of the stator 102. This gap 410 advantageously tends to reduce the transfer of heat from the stator 102 and the first end plate 120 to the support member 400.

The first end plate 120 comprises a first surface 412 that is furthest from the pumping chamber 104 (and is directly adjacent to or contacts the gap 410), a second surface 414 opposite to the first surface 412 and closest to the pumping chamber 104, and one or more side surfaces 416 disposed between the first surface 412 and the second surface 414.

In this embodiment, the first end plate 120 comprises a first purge gas channel 420. The first purge gas channel 420 comprises a first inlet 422 and a first outlet 424. The first outlet 424 of the first purge gas channel 420 may be formed in the first surface 412 of the first end plate 120. The first inlet 422 of the first purge gas channel 420 may be formed in the second surface 414 of the first end plate 120.

In this embodiment, the stator 102 comprises a second purge gas channel 430. More specifically, in this embodiment, the first end wall 110 comprises the second purge gas channel 430. The second purge gas channel 430 comprises a second inlet 432 and a second outlet 434. The second outlet 434 of the second purge gas channel 420 is in fluid communication with the first inlet 422 of the first purge gas channel 420.

In use, a purge gas (i.e. a relatively inert gas such as nitrogen), may be introduced into the second inlet 432 of the second purge gas channel 430. The purge gas flows through the second purge gas channel 430, then through the first purge gas channel 420, and out of the first outlet 424 of the first purge gas channel 420, and into the gap 410. The introduction of the purge gas into the gap 410 between the stator 102/first end plate 120, the support member 400, and the sealing gasket 122 advantageously tends to create a relatively high pressure within the gap 410, thereby reducing the likelihood of the ingress of process gases into the gap 410, for example through the apertures 126 or through the first opening 116. This advantageously tends to reduce contact of the processes gases with the support member 400, which may be detrimental to the operation of the bearings 402. Further, since the support member 400 is relatively cool compared to the stator 102, there tends to be reduced condensation of process gases caused by contact with the support member 400.

In accordance with the present invention, the first end plate 120 is a thermal break or thermal break plate. Use of the first end plate 120 tends to prevent or reduce the transfer of thermal energy from the stator 102 to the support member 400.

Advantageously, the first end plate, i.e. the stator thermal break insert, tends to prevent or oppose process gas from coming into contact with the surface of the support member (i.e. the headplate). Also, good alignment between the support member (i.e. the headplate) which carries the shaft bearings and the stator of the pump mechanism tends to be provided.

As mentioned above, conventionally, in pumps that incorporate a thermal break plate, for each thermal break plate, two sealing gaskets (e.g., O-ring seals) are used: one to provide sealing between the thermal break plate and the stator and another to provide sealing between the thermal break plate and the headplate. In applications that involve the sealing gaskets coming into contact with high temperature or corrosive fluids, the sealing gaskets can be prone to corrosion, be difficult to produce, and/or be expensive. Advantageously, the above-described vacuum pump uses, for each thermal break plate (i.e. for the first end plate), only a single such sealing gasket/O-ring seals. In particular, use of a sealing gasket between the thermal break plate and the stator tends to be eliminated. This advantageously tends to reduce potential leak paths and save cost.

Advantageously, locating the first end plate, i.e. the thermal break plate, in a recess formed in the stator tends to reduce the overall length of the vacuum pump. Thus, the vacuum pump tends to have a reduced footprint.

Advantageously, the above-described vacuum pump is particularly useful for hot screw pumps that will be used for semiconductor applications requiring high temperature pumps. The above-described vacuum pump tends to reduce or prevent high temperature process gasses from coming into contact with relatively cold surfaces within the pump mechanism. The thermal break plate/insert (i.e. the first end plate) may be at the same temperature as the stator.

Advantageously, the stator being open at its first end (i.e., via the first opening) tends to allow for the machining, repair, inspection, etc. of the stator from this end.

Advantageously, the locating protrusions tend to accurately locate the support member and bearings with respect to the stator and rotor shafts.

Conventionally, a screw stator may be aligned with a headplate that carries the bearings by dowels that are located on the horizontal centre line on the outer edges of the stator. This may work well, providing the headplate and stator are at similar temperatures. However, if a stator operates at a higher temperate than the headplate (e.g., if a stator operates at a temperature of about 200° C., while the headplate is at 100° C.), then the alignment of the pump rotor bores with the bearings may become compromised as the dowel centres on the stator expand to a value that is larger than the dowel centres of the headplate. For example, if the dowels between headplate and stator are on 250 mm centres and the materials have an expansion coefficient of 10×10⁻⁶ mm/mm/° C., then the dowels, with a 100° C. temperature differential of stator to headplate, will be on centres that differ by 0.25 mm. Advantageously, the above described thermal break insert (i.e. the first end plate), with the central round dowel/locating protrusion 124a, tends to keep the stator and headplate centrally aligned. The two edge locating protrusions 124b (i.e., the so-called “acorn dowels”) on the horizontal centre line either side of the central round dowel/locating protrusions 124a, tend to allow the stator to be hotter than the headplate whilst maintaining good alignment. The two edge locating protrusions 124b may be a tight fit in the thermal break insert (i.e. the first end plate), but may have a small clearance in the headplate. This allows the two edge locating protrusions 124b to move side to side within the headplate dowel holes which have a small clearance.

Advantageously, the dowel holes in the thermal break insert (i.e. the first end plate) can be machined from one side of the thermal break insert. This tends to ensure good positional alignment of the stator and headplate. For corrosion protection of the three locating protrusions/dowels, the dowel holes may be blind drilled from the side that faces the headplate.

In the above embodiments, the vacuum pump is a dry rotary screw vacuum pump. However, in other embodiments, the vacuum pump is a different type of vacuum pump.

In the above embodiments, the first end wall comprises a first opening therethrough. The first opening is an opening to the pumping chamber. The first end plate is disposed in the first opening, and may act as a thermal break plate or insert. In some embodiments, the vacuum pump comprises a substantially identical or similar structure at the second end 113 of the stator 102. For example, in some embodiments, the second end wall 112 of the stator 102 comprises a second opening therethrough. The second opening advantageously tends to allow access to the pumping chamber 104, e.g. by a human or tool (such as a machining tool) during fabrication, servicing, or repair, etc. of the stator 102. Thus, in some embodiments, the internal cavity of the stator 102 can be accessed from both ends, i.e. from the first end 111 and the second end 113. The vacuum pump 100 may further comprise a second end plate that is removably disposed in the second opening. The second end wall 112 may comprise a recessed flange extending from internal walls of the second opening upon which the second end plate is seated. The second end plate may have substantially the same construction and/or shape as the first end plate 120.

In the above embodiments, the first end plate may be made of the same material as the stator. However, in other embodiments, the first end plate is made of or comprises a different material to that of the stator, such as a Ni-resist, which may provide improved corrosion protection.

In the above embodiments, the first end plate is fixedly attached to the stator by a plurality of fasteners which pass through the first end plate and the flange. However, in other embodiments, the first end plate is fixedly attached to the stator in a different way, and/or by a different number of fasteners to that described above and shown in the Figures.

In the above embodiments, the sealing gasket is made of a perfluoroelastomer (FFKM). However, in other embodiments, the sealing gasket is made of a different appropriate material, such as a fluoroelastomer (FKM/FPM).

In the above embodiments, the first end plate comprises three dowels or locating protrusions for accurately locating the support member/headplate. However, in other embodiments, the first end plate comprises a different number of dowels or locating protrusions other than three. In some embodiments, the dowels or locating protrusions have a different arrangement other than being arranged along the horizontal centreline of the first end plate. In some embodiments, the vacuum pump comprises different alignment features for aligning or positioning the support member/headplate relative to the stator. In some embodiments, the dowels or locating protrusions are omitted.

In the above embodiments, the vacuum pump comprises four ceramic spacers for spacing apart the support member from the first end wall and the first end plate. However, in other embodiments, there is a different number of ceramic spacers. In some embodiments, one or more of the spacers is made of a different material other than a ceramic. In some embodiments, the ceramic spacers may be omitted.

In the above embodiments, the first end plate comprises a first purge gas channel. The inlet of the first purge gas channel is formed in the second surface of the first end plate. However, in other embodiments, the inlet of the first purge gas channel is formed in a different surface of the first end plate such as the one or more side surfaces. In some embodiments, the purge gas channel may be omitted. Also, the second purge gas channel may be omitted.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pump comprising:
a stator, the stator comprising:
a first end wall at a first end of the stator;
a second end wall at a second end of the stator, the second end of the stator being opposite to the first end of the stator; and
one or more side walls disposed between the first end wall and the second end wall; wherein
the first end wall, the second end wall, and the one or more side walls define a pumping chamber;
the first end wall comprises a first opening therethrough; and
the vacuum pump further comprises a first end plate removably disposed in the first opening;
wherein the first end plate is a thermal break plate.

2. The vacuum pump of claim 1, wherein the first end plate is wholly recessed in the first end wall.

3. The vacuum pump of claim 1, a wherein the first end wall comprises a recessed flange extending from internal walls of the first opening, and the first end plate abuts the recessed flange.

4. The vacuum pump of claim 1, further comprising a sealing gasket disposed against the first end wall and surrounding the first end plate.

5. The vacuum pump oft claim 1, wherein the vacuum pump comprises a dry screw vacuum pump.

6. The vacuum pump of an claim 1, further comprising:
one or more rotatable shafts; and
a support member comprising bearings for mounting the rotatable shafts; wherein each rotatable shaft comprises at least one rotor element;
each rotor element is within the pumping chamber; and
each rotatable shaft extends beyond the first end of the stator, through a respective hole through the first end plate, and to the support member whereat the rotatable shaft is mounted on the bearings; and
the support member is positioned facing and spaced apart from the first end wall and the first end plate.

7. The vacuum pump of claim 6, wherein the first end plate comprises a plurality of locating protrusions extending therefrom, each locating protrusion being received in a respective hole formed in the support member.

8. The vacuum pump of claim 6, wherein the locating protrusions are made from a material selected from the group of materials consisting of stainless steel, carbon steel, and mild steel.

9. The vacuum pump of claim 6, wherein the sealing gasket seals against the first end wall and the support member.

10. The vacuum pump of claim 6, further comprising one or more ceramic spacers disposed between the first end wall and the support member.

11. The vacuum pump of claim 1, wherein the first end plate comprises:
a purge gas channel, the purge gas channel comprising:
an inlet for receiving a purge gas; and
an outlet via which the purge gas may exit the purge gas channel.

12. The vacuum pump of claim 11, wherein the first end plate comprises:
a first surface that is furthest from the pumping chamber;
a second surface opposite to the first surface, the second surface being closest to the pumping chamber; and
one or more side surfaces disposed between the first surface and the second surface;
wherein the outlet of the purge gas channel is formed in the first surface.

13. The vacuum pump of claim 11, wherein the first end plate comprises:
a first surface that is furthest from the pumping chamber;
a second surface opposite to the first surface, the second surface being closest to the pumping chamber; and
one or more side surfaces disposed between the first surface and the second surface; wherein
the inlet of the purge gas channel is formed in the second surface or the one or more side surfaces.

14. The vacuum pump of claim 1, wherein:
the second end wall comprises a second opening therethrough; and
the vacuum pump further comprises a second end plate removably disposed in the second opening.
